(19) United States
(12) Patent Application Publication
(10) Pub. No.: US 2018/0145863 A1
(43) Pub. Date: May 24, 2018

(54) METHODS AND SYSTEMS FOR DETERMINING OPTIMAL PACKETS

(71) Applicants: Khalifa University of Science, Technology, and Research, Abu Dhabi (AE); British Telecommunications plc, London (GB); Emirates Telecommunications Corporation, Abu Dhabi (AE)

(72) Inventors: Zdenek Chaloupka, Noordwijk (NL); Ivan Boyd, Abu Dhabi (AE)

(21) Appl. No.: 15/358,315

(22) Filed: Nov. 22, 2016

(51) Int. Cl. H04L 27/26; H04L 12/26; H04L 7/00

(52) U.S. Cl. CPC H04L 27/2657; H04L 67/42; H04L 7/0079; H04L 43/0852

(57) ABSTRACT

This invention relates to timing message selection techniques that can be used in conjunction with a clock recovery mechanism to mitigate the effects of packet delay variation on timing messages exchanged over a packet network, particularly when seeking to synchronize the time of a clock in a slave device to that of a master clock. The selection techniques allow the identification of optimal or minimally-delayed timing messages which can subsequently be used in timing synchronisation. Embodiments of the invention provide techniques which identify optimal timing messages in both forward and reverse directions which are then processed to form composite timing messages which are used in a frequency estimation algorithm. Timing messages selected by the methods of the invention are particularly useful in phase synchronization between the master and slave clocks.

### FIELD OF THE INVENTION

The present invention relates to methods and systems for determining optimal messages transmitted over a packet network. It is particularly, but not exclusively, related to methods and systems which identify optimal messages in both forward and reverse transmission directions and make use of these messages in a frequency and phase offset synchronization estimation algorithm (for example under IEEE 1588 PTP).

### BACKGROUND OF THE INVENTION

Timing synchronization using a protocol such as IEEE 1588 PTP and a well-designed slave clock recovery mechanism can provide time synchronization in the sub-microsecond level and lower. Time synchronization requires an accurate measurement of the communication path delay between the time server (master) and the client (slave) in order to compute the time offset between them.

It has been observed by many researchers and telecom engineers that Packet Delay Variation (PDV) has the most significant impact on the precision and accuracy of the synchronization algorithms deployed over packet networks (over protocols like IEEE 1588v2 PTP, or NTP). In order to mitigate PDV a number of techniques can be employed (filtering, packet selection, etc.). All these techniques have one thing in common: the need to find a reliable and easily detectable reference that does not change (vary) significantly over time.

In most existing approaches, the path delay estimation is based on the important assumption that the time delay from master to slave is equal to that from slave to master. However, in reality, the communication paths are not perfectly symmetric, mainly due to dissimilar forward and reverse physical link delays and queuing delays. Even in cases where the physical link delays are known and properly compensated for during clock synchronization, queuing delays which are variable can still exist when timing messages go through the packet network and queued for forwarding. In particular, the processing and buffering of packets in network devices (switches, routers, etc.) introduce variations in the time latency of packets traversing the packet network. This mainly happens when timing transfer is done in an end-to-end manner without any form timing assistance from the network to help mitigate the effects of the variable queuing delays.

Variable queueing delays and any asymmetry in the forward and reverse queuing delays directly lead to increased errors in the phase offset estimation between a master and slave.

One known approach to improve frequency synchronization between the slave and the master clocks is to use packet selection to pick a set of Minimally Delayed Packets (MDPs), sometimes referred to as “lucky” packets. MDPs will occur quite frequently in telecom networks where traffic load does not cross certain threshold (usually 50% load) and there is a limited number of network interconnecting devices (up to 10 enterprise switches, see ITU-T G.8261). The MDP(s) are selected per window of samples and only these packets are used in the updating of the estimation algorithm. US2015/0163154 is an example of such a method.

There are a number of questions that need to be answered to enable MDPs to be used for reliable time & frequency synchronization:
a) What is the best way to make use of MDPs to synchronize a slave clock to a master?
b) How can the MDP be detected using a slave device clock, when the slave clock is both skewed and offset from the master clock?
c) How can MDP detection be implemented during higher load conditions, where MDPs occur only once or twice during a typical window length of 60 seconds?
d) How can time & frequency synchronization accuracy be maintained during the period of time from one MDP until the next occurrence?

For frequency synchronisation, packets from one direction only (e.g., the forward direction) can be used by a frequency estimation algorithm. However for phase synchronisation, both forward and reverse packets are required. Selecting a minimally delayed packet in the forward direction does not mean that the corresponding message response of the two-way exchange in the reverse direction is also minimally delayed. Indeed this is highly unlikely, even when the network loads in the forward and reverse directions are also almost the same, unless both paths are very lightly loaded. The same is true if the minimally delayed packet in the reverse direction is selected; the corresponding forward packet is most probably not minimally delayed.

Accordingly, an object of the present invention is to provide a packet selection approach which is particularly well suited to phase synchronisation.

Further objects of the present invention are to provide a packet selection approach which exhibits significant improvements in the responses to the above questions.

### SUMMARY OF THE INVENTION

An exemplary embodiment of the invention provides a method of estimating the phase offset between a master clock in a server and a slave clock in a client, the server and the client being in communication over a network, the method including the steps of: within a time window of predetermined duration, exchanging timing messages between the server and the client and recording timestamps which are the times of sending and of receipt of those messages according to the master and slave clocks; determining, from those timestamps, at least one first timestamp pair, which is the times of sending and receipt associated with the least delayed timing message sent from the server to the client in the window; determining, from those timestamps, at least one second timestamp pair, which is the times of sending and receipt associated with the least delayed timing messages sent from the client to the server in the window; generating, from the first and second timestamp pairs at least one composite timing message, which includes said first timestamp pair and said second timestamp pair; using said composite timing messages to estimate the phase offset between the master clock and the slave clock.

A further exemplary embodiment of the invention provides a time client having a slave clock and a processor, and connected to a master clock in a server over a network, wherein the time client is arranged to: within a time window of predetermined duration, exchange timing messages with the server and record and receive timestamps which are the times of sending and of receipt of those messages according to the master and slave clocks, and wherein the processor is arranged to: determine, from those timestamps, at least one first timestamp pair, which is the times of sending and receipt associated with the least delayed timing message sent from the server to the client in the window; determine, from those timestamps, at least one second timestamp pair, which is the times of sending and receipt associated with the least delayed timing message sent from the client to the server in the window; generate, from the first and second plurality of timestamps at least one composite timing message, which includes said first timestamp pair and said second timestamp pair; and use said composite timing messages to estimate the phase offset between the master clock and the slave clock.

A further exemplary embodiment of the invention provides a networked time system having: a time server which has a master clock; a time client having a slave clock and a processor; and a network connecting said server and said client, wherein the server and the client are arranged to, within a time window of predetermined duration, exchange timing messages with each other and record timestamps which are the times of sending and of receipt of those messages according to the master and slave clocks, and wherein the processor in the client is arranged to: determine, from those timestamps, at least one first timestamp pair, which is the times of sending and receipt associated with the least delayed timing message sent from the server to the client in the window; determine, from those timestamps, at least one second timestamp pair, which is the times of sending and receipt associated with the least delayed timing message sent from the client to the server in the window; generate, from the first and second timestamp pairs at least one composite timing message, which includes said first timestamp pair and said second timestamp pair; and use said composite timing messages to estimate the phase offset between the master clock and the slave clock.

### BRIEF DESCRIPTION OF THE DRAWINGS

Embodiments of the invention will now be described by way of example with reference to the accompanying drawings in which:

FIG. 1 is a graphical representation of the relationship between θ_{Ef}, θ_{Er} and θ_{E}[n], as defined in the embodiments of the invention;

FIG. 2 shows the operation of a phase offset estimation process according to an embodiment of the present invention over a plurality of time windows;

FIG. 3 is a graphical representation of the relationship between θ_{Ef}, θ_{Er} and θ_{E}[n], as defined in the embodiments of the invention showing the calculations of biases; and

FIG. 4 shows the impact of a large change in the network load on the reverse path on the calculation of least delayed timing messages and illustrates how this change can be detected and compensated for in embodiments of the present invention.

### DETAILED DESCRIPTION

At their broadest, aspects of the present invention provide for methods and systems which separately identify the least delayed timing messages in the forward and reverse directions and use these to create a composite timing message for use in estimation of phase offset.

A first aspect of the present invention provides a method of estimating the phase offset between a master clock in a server and a slave clock in a client, the server and the client being in communication over a network, the method including the steps of: within a time window of predetermined duration, exchanging timing messages between the server and the client and recording timestamps which are the times of sending and of receipt of those messages according to the master and slave clocks; determining, from those timestamps, at least one first timestamp pair, which is the times of sending and receipt associated with the least delayed timing message sent from the server to the client in the window; determining, from those timestamps, at least one second timestamp pair, which is the times of sending and receipt associated with the least delayed timing messages sent from the client to the server in the window; generating, from the first and second timestamp pairs at least one composite timing message, which includes said first timestamp pair and said second timestamp pair; using said composite timing messages to estimate the phase offset between the master clock and the slave clock.

In certain embodiments, a plurality of timestamp pairs for each of the forward and reverse directions are determined and used. In such embodiments, the steps of determining and generating include: determining, from those timestamps, a first plurality of timestamp pairs, each of which are the times of sending and receipt associated with the least delayed timing messages sent from the server to the client in the window; determining, from those timestamps, a second plurality of timestamp pairs, each of which are the times of sending and receipt associated with the least delayed timing messages sent from the client to the server in the window; generating, from the first and second plurality of timestamps a plurality of composite timing messages, each of which includes one of said first plurality of timestamp pairs and one of said second plurality of timestamp pairs.

Preferably the composite timing messages are also used to estimate the skew between the master clock and the slave clock.

The network may be a packet network (using technologies such Ethernet, IP, MPLS, etc.).

The timing messages are preferably timing messages under the IEEE 1588 Precision Time Protocol (PTP).

The method of this aspect can identify a set of minimally delayed packets (MDPs) or timing messages in the forward and reverse directions within a window of samples. Composites of these MDPs can be created and these composites represent packets or timing messages which would be minimally delayed in both the forward and reverse directions. As these composites are minimally delayed in both directions, their variability, magnitude and the degree of asymmetry are all minimised. These composites are therefore very valuable timing messages to use to update a Kalman filter (or any other) estimation algorithm.

The composite timing messages generated in the method of this aspect are ideal for updating the estimation algorithm for phase and frequency synchronisation as they are minimally delayed, have lower variance and suffer less asymmetry than any other timing messages in the window of samples from which they were created. Updating the estimation algorithm with better data can improve the accuracy of the estimation process.

The composite timing messages may also include further time information, either derived directly from the timestamps or calculated from the least delayed timing messages from which the composite timing message is generated.

In certain embodiments, said estimation of the phase offset includes operating a Kalman filter using the timestamps of said timing messages, and in particular may include the steps of: initialising the Kalman filter by operating it using the measured timestamps of said timing messages until the estimates of the phase offset and skew are estimated to within a predetermined accuracy; and then repeatedly for each time window: operating the Kalman filter in prediction only mode to estimate the instantaneous phase offset based on the state vector derived from the composite timing message or messages from the previous time window; generating the composite timing message or messages for the current time window; and at the end of each time window, updating the Kalman filter with the values from the composite timing message or messages from the time window just ended.

In this manner, the Kalman filter can operate only on timing messages which have been identified as being minimally delayed and optimal. As there are a reduced number of these (compared, for example, to operating the estimation on timestamps from every exchange of timing messages), the update can be performed quickly at the end of each window, preferably between the last timing message of the preceding window and the first timing message of the next window.

The initialising step can be accomplished by a number of means, such as, for example, identifying lightly loaded conditions and operating the Kalman filter on each timestamp under such conditions.

Whilst the above embodiments use a Kalman filter, it will be appreciated that similar principles can be applied to other estimation/prediction models such as those described in Bletsas et al. [3].

Preferably the method further includes the steps of: calculating, for each of said least delayed timing messages, an estimate of the phase offset; and calculating, for each of said composite timing messages, an estimated mean phase offset which is the geometric mean of: the phase offset calculated for the timing message associated with said one of said first plurality of timestamps and the phase offset calculated for the timing message associated with said one of said second plurality of timestamps.

The estimated mean phase offset can then be used as the input to an estimation algorithm, such as a Kalman filter.

Preferably the method further includes the step of calculating, as the time associated with each estimated mean phase offset, the geometric mean of the times of sending or receipt of the timing messages from which the estimated mean phase offset is derived.

Thus a plurality of composite timing messages can be created which have a phase offset and a time which represents the average of those values as calculated from the pair of least delayed timing messages which have been chosen to create the composite timing message.

In certain embodiments, the estimation of the phase offset includes using the thus-constructed composite timing messages and operating a Kalman filter using the timestamps of said timing messages, and more preferably includes the steps of: initialising the Kalman filter by operating it using the measured timestamps of said timing messages until the estimates of the phase offset and skew are estimated to within a predetermined accuracy; and then repeatedly for each time window: operating the Kalman filter in prediction only mode to estimate the instantaneous phase offset based on the state vector derived from the composite timing messages from the previous time window; generating the composite timing messages for the current time window; and at the end of each time window, updating the Kalman filter with the values from the composite timing messages from the time window just ended, wherein the Kalman filter operates with a measurement equation:

$$\frac{( {T}_{1} [ {n}_{0} ] - {T}_{2} [ {n}_{0} ] ) + ( {T}_{4} [ {n}_{1} ] - {T}_{3} [ {n}_{1} ] )}{2} = {θ}_{E}$$

and a state equation:

$${X}_{n} = [ \begin{matrix}{θ}_{n} \\ {α}_{n}\end{matrix} ] = [ \begin{matrix}1 & Δ T \\ 0 & 1\end{matrix} ] [ \begin{matrix}{θ}_{n - 1} \\ {α}_{n - 1}\end{matrix} ] + [ \begin{matrix}{w}_{θ , n} \\ {w}_{α , n}\end{matrix} ] = {AX}_{n - 1} + {w}_{n} ,$$

and further wherein, after the step of initialising the Kalman filter:
T₁[n₀], T₂[n₀], T₃[n₁] and T₄[n₁] are, respectively, the time of sending of the least delayed timing message, from which the composite timing message is generated, sent from the server to the client; the time of receipt of said least delayed timing message sent from the server to the client; the time of sending of the least delayed timing message, from which the composite timing message is generated, sent from the client to the server; and the time of receipt of said least delayed timing message sent from the client to the server; θ_{E} is the estimated mean phase offset value used by the estimation algorithm; θₙ and αₙ are the offset and skew estimates of the slave clock compared to the master at time n at the output of the estimation algorithm; ΔT is the time period between the time associated with consecutive estimated mean phase offsets.

In certain embodiments the steps of detecting the least delayed timing messages in each direction include: determining, from said timestamps, a forward displacement factor which is the difference between the interval between the times of receipt of successive first timing messages by the client and the interval between the times of sending of said successive first messages by the server; determining, from said timestamps, a reverse displacement factor which is the difference between the interval between the times of receipt of successive second timing messages by the server and the interval between the times of sending of said successive second timing messages by the client; maintaining a running sum of said forward displacement factors over a predetermined time period; maintaining a running sum of reverse displacement factors over a predetermined time period; and determining the least delayed timing messages from said running sums.

In certain embodiments, the method further includes the step of estimating the variance of the measurement noise for the phase offset estimated for each of the least delayed timing messages. For example, this may be done by comparing the distance between the running sums of displacement factors at the times of the least delayed timing messages.

In certain embodiments the method may include the further steps of determining or estimating the bias or offset between the instantaneous phase offset predicted by the estimation algorithm and the phase offset estimated directly from the least delayed timing messages. A stable estimate of this bias can be obtained by determining the bias from a plurality of least delayed timing messages and averaging them, for example using a exponentially weighted moving average filter.

The method may use this estimated bias in the event that it becomes impossible to obtain timing messages or timestamps in one of the directions, or in the event that timing messages in one direction are subject to significant disruption or delay.

In such situations, the bias may be used to estimate the instantaneous phase offset from the timing messages which are received or which are not subject to disruption or delay.

The calculation of such a bias can also be used as a check on new candidates for least delayed timing messages. For example, if the absolute distance of the phase offset estimated from a candidate least delayed timing message from the predicted phase offset using the bias is above a predetermined threshold then the candidate least delayed timing message can be ignored and not used in future updates.

In certain embodiments the method further includes the step of determining the load conditions on the network between the server and the client and, if the load conditions are determined to be low in a window, storing the composite timing messages determined in said window, whilst, if the load conditions are determined to be high in a window, using stored composite timing messages from an earlier window in the estimation of the phase offset.

In high network load conditions or when there is a change to the routing of traffic, the absolute delay of the least delayed timing messages can increase significantly. This shift in the values of the least delayed timing messages can result in the method of this aspect having difficulty or even being unable to detect/verify the true least delayed timing messages and may therefore result in no composite timing messages being created for use in the estimation process for the phase offset. This can impair the timing synchronisation and cause decline in the accuracy of the synchronization approach.

Preferably these embodiments operate by detecting changes in network load conditions (both increases and decreases in network load) and determining any significant changes. When a significant change in load condition is determined the shift in phase is considered and can be used to modify the attributes associated with the least delayed timing messages.

Preferably the step of determining the load conditions includes the sub-steps of: calculating an estimate of a statistical characteristic of the queuing delay in each of said windows; and comparing the estimate from the window in which the load conditions are being determined with the estimate from one or more previous windows and comparing the differences to a predetermined threshold.

Preferably if the load conditions are determined to be high in a particular window, the stored composite timing messages are used to adjust composite timing messages determined in that window.

Thus the effects of high load conditions on the determination of the least delayed timing messages and their use can be reduced or minimized.

The method of the present aspect may include any combination of some, all or none of the above described preferred and optional features.

The method of the above aspect is preferably implemented by a time client according to the second aspect of this invention, as described below, or a system according to the third aspect of this invention, as described below, but need not be.

Further aspects of the present invention include computer programs for running on computer systems which carry out the method of the above aspect, including some, all or none of the preferred and optional features of that aspect.

A second aspect of the present invention provides a time client having a slave clock and a processor, and connected to a master clock in a server over a network, wherein the time client is arranged to: within a time window of predetermined duration, exchange timing messages with the server and record and receive timestamps which are the times of sending and of receipt of those messages according to the master and slave clocks, and wherein the processor is arranged to: determine, from those timestamps, at least one first timestamp pair, which is the times of sending and receipt associated with the least delayed timing message sent from the server to the client in the window; determine, from those timestamps, at least one second timestamp pair, which is the times of sending and receipt associated with the least delayed timing message sent from the client to the server in the window; generate, from the first and second plurality of timestamps at least one composite timing message, which includes said first timestamp pair and said second timestamp pair; and use said composite timing messages to estimate the phase offset between the master clock and the slave clock.

In certain embodiments, a plurality of timestamp pairs for each of the forward and reverse directions are determined and used. In such embodiments, the processor is arranged to determine timestamp pairs and generate composite timing messages by: determining, from those timestamps, a first plurality of timestamp pairs, each of which are the times of sending and receipt associated with the least delayed timing messages sent from the server to the client in the window; determining, from those timestamps, a second plurality of timestamp pairs, each of which are the times of sending and receipt associated with the least delayed timing messages sent from the client to the server in the window; generating, from the first and second plurality of timestamps a plurality of composite timing messages, each of which includes one of said first plurality of timestamp pairs and one of said second plurality of timestamp pairs.

Preferably the composite timing messages are also used to estimate the skew between the master clock and the salve clock.

The network may be a packet network (using technologies such Ethernet, IP, MPLS, etc.).

The timing messages are preferably timing messages under the IEEE 1588 Precision Time Protocol (PTP).

The time client of this aspect can identify a set of minimally delayed packets (MDPs) or timing messages in the forward and reverse directions within a window of samples. Composites of these MDPs can be created and these composites represent packets or timing messages which would be minimally delayed in both the forward and reverse directions. As these composites are minimally delayed in both directions, their variability, magnitude and the degree of asymmetry are all minimised. These composites are therefore very valuable timing messages to use to update a Kalman filter (or any other) estimation algorithm.

The composite timing messages generated in the time client of this aspect are ideal for updating the estimation algorithm for phase and frequency synchronisation as they are minimally delayed, have lower variance and suffer less asymmetry than any other timing messages in the window of samples from which they were created. Updating the estimation algorithm with better data can improve the accuracy of the estimation process.

The composite timing messages may also include further time information, either derived directly from the timestamps or calculated from the least delayed timing messages from which the composite timing message is generated.

In certain embodiments, when performing said estimation of the phase offset, the processor is further arranged to: operate a Kalman filter using the timestamps of said timing messages, including the steps of: initialising the Kalman filter by operating it using the measured timestamps of said timing messages until the estimates of the phase offset and skew are estimated to within a predetermined accuracy; and then repeatedly for each time window: operating the Kalman filter in prediction only mode to estimate the instantaneous phase offset based on the state vector derived from the composite timing message or messages from the previous time window; generating the composite timing message or messages for the current time window; and at the end of each time window, updating the Kalman filter with the values from the composite timing message or messages from the time window just ended.

In this manner, the Kalman filter can operate only on timing messages which have been identified as being minimally delayed and optimal. As there are a reduced number of these (compared, for example, to operating the estimation on timestamps from every exchange of timing messages), the update can be performed quickly at the end of each window, preferably between the last timing message of the preceding window and the first timing message of the next window.

The initialising step can be accomplished by a number of means, such as, for example, identifying lightly loaded conditions and operating the Kalman filter on each timestamp under such conditions.

Whilst the above embodiments use a Kalman filter, it will be appreciated that similar principles can be applied to other estimation/prediction models such as those described in Bletsas et al. [3].

Preferably the processor is further arranged to: calculate, for each of said least delayed timing messages, an estimate of the phase offset; and calculate, for each of said composite timing messages, an estimated mean phase offset which is the geometric mean of: the phase offset calculated for the timing message associated with said one of said first plurality of timestamps and the phase offset calculated for the timing message associated with said one of said second plurality of timestamps.

The estimated mean phase offset can then be used as the input to an estimation algorithm, such as a Kalman filter.

Preferably the processor is further arranged to calculate, as the time associated with each estimated mean phase offset, the geometric mean of the times of sending or receipt of the timing messages from which the estimated mean phase offset is derived.

Thus a plurality of composite timing messages can be created which have a phase offset and a time which represents the average of those values as calculated for the two least delayed timing messages which have been used to create the composite timing message.

In certain embodiments, when performing said estimation of the phase offset, the processor is further arranged to: operate a Kalman filter using the timestamps of said timing messages, including the steps of: initialising the Kalman filter by operating it using the measured timestamps of said timing messages until the estimates of the phase offset and skew are estimated to within a predetermined accuracy; and then repeatedly for each time window: operating the Kalman filter in prediction only mode to estimate the instantaneous phase offset based on the state vector derived from the composite timing messages from the previous time window; generating the composite timing messages for the current time window; and at the end of each time window, updating the Kalman filter with the values from the composite timing messages from the time window just ended, wherein the Kalman filter operates with a measurement equation:

$$\frac{( {T}_{1} [ {n}_{0} ] - {T}_{2} [ {n}_{0} ] ) + ( {T}_{4} [ {n}_{1} ] - {T}_{3} [ {n}_{1} ] )}{2} = {θ}_{E}$$

and a state equation:

$${X}_{n} = [ \begin{matrix}{θ}_{n} \\ {α}_{n}\end{matrix} ] = [ \begin{matrix}1 & Δ T \\ 0 & 1\end{matrix} ] [ \begin{matrix}{θ}_{n - 1} \\ {α}_{n - 1}\end{matrix} ] + [ \begin{matrix}{w}_{θ , n} \\ {w}_{α , n}\end{matrix} ] = {AX}_{n - 1} + {w}_{n} ,$$

and further wherein, after the step of initialising the Kalman filter:
T₁[n₀], T₂[n₀], T₃[n₁] and T₄[n₁] are, respectively, the time of sending of the least delayed timing message, from which the composite timing message is generated, sent from the server to the client; the time of receipt of said least delayed timing message sent from the server to the client; the time of sending of the least delayed timing message, from which the composite timing message is generated, sent from the client to the server; and the time of receipt of said least delayed timing message sent from the client to the server; θ_{E} is the estimated mean phase offset value used by the estimation algorithm; θₙ and αₙ are the offset and skew estimates of the slave clock compared to the master at time n at the output of the estimation algorithm; ΔT is the time period between the time associated with consecutive estimated mean phase offsets.

In certain embodiments, when detecting the least delayed timing messages in each direction, the processor is arranged to: determine, from said timestamps, a forward displacement factor which is the difference between the interval between the times of receipt of successive first timing messages by the client and the interval between the times of sending of said successive first messages by the server; determine, from said timestamps, a reverse displacement factor which is the difference between the interval between the times of receipt of successive second timing messages by the server and the interval between the times of sending of said successive second timing messages by the client; maintain a running sum of said forward displacement factors over a predetermined time period; maintain a running sum of reverse displacement factors over a predetermined time period; and determine the least delayed timing messages from said running sums.

In certain embodiments, the processor is further arranged to estimate the variance of the measurement noise for the phase offset estimated for each of the least delayed timing messages. For example, this may be done by comparing the distance between the running sums of displacement factors at the times of the least delayed timing messages.

In certain embodiments the processor may be further arranged to determine or estimate the bias or offset between the instantaneous phase offset predicted by the estimation algorithm and the phase offset estimated directly from the least delayed timing messages. A stable estimate of this bias can be obtained by determining the bias from a plurality of least delayed timing messages and averaging them, for example using an exponentially weighted moving average filter.

The processor may use this estimated bias in the event that it becomes impossible to obtain timing messages or timestamps in one of the directions, or in the event that timing messages in one direction are subject to significant disruption or delay.

In such situations, the bias may be used to estimate the instantaneous phase offset from the timing messages which are received or which are not subject to disruption or delay.

The calculation of such a bias can also be used as a check on new candidates for least delayed timing messages. For example, if the absolute distance of the phase offset estimated from a candidate least delayed timing message from the predicted phase offset using the bias is above a predetermined threshold then the candidate least delayed timing message can be ignored and not used in future updates.

In certain embodiments, the processor is further arranged to determine the load conditions on the network between the server and the client and, if the load conditions are determined to be low in a window, store the composite timing messages determined in said window in a memory, whilst, if the load conditions are determined to be high in a window, use composite timing messages from an earlier window stored in said memory in the estimation of the phase offset.

In high network load conditions or when there is a change to the routing of traffic, the absolute delay of the least delayed timing messages can increase significantly. This shift in the values of the least delayed timing messages can result in the method of this aspect having difficulty or even being unable to detect/verify the true least delayed timing messages and may therefore result in no composite timing messages being created for use in the estimation process for the phase offset. This can impair the timing synchronisation and cause decline in the accuracy of the synchronization approach.

Preferably these embodiments operate by detecting changes in network load conditions (both increases and decreases in network load) and determining any significant changes. When a significant change in load condition is determined the shift in phase is considered and can be used to modify the attributes associated with the least delayed timing messages.

Preferably, when determining the load conditions, the processor is arranged to: calculate an estimate of a statistical characteristic of the queuing delay in each of said windows; and compare the estimate from the window in which the load conditions are being determined with the estimate from one or more previous windows and comparing the differences to a predetermined threshold.

Preferably, if the load conditions are determined to be high in a window, the processor is arranged to use composite timing messages stored in said memory to adjust composite timing messages determined in that window.

Thus the effects of high load conditions on the determination of the least delayed timing messages and their use can be reduced or minimized.

The time client of the present aspect may include any combination of some, all or none of the above described preferred and optional features.

The processor of the slave device of the above aspect preferably operates by performing a method according to the first aspect of this invention, as described above, but need not do so.

A further aspect of the present invention provides a networked time system having: a time server which has a master clock; a time client having a slave clock and a processor; and a network connecting said server and said client, wherein the server and the client are arranged to, within a time window of predetermined duration, exchange timing messages with each other and record timestamps which are the times of sending and of receipt of those messages according to the master and slave clocks, and wherein the processor in the client is arranged to: determine, from those timestamps, at least one first timestamp pair, which is the times of sending and receipt associated with the least delayed timing message sent from the server to the client in the window; determine, from those timestamps, at least one second timestamp pair, which is the times of sending and receipt associated with the least delayed timing message sent from the client to the server in the window; generate, from the first and second timestamp pairs at least one composite timing message, which includes said first timestamp pair and said second timestamp pair.

In certain embodiments, a plurality of timestamp pairs for each of the forward and reverse directions are determined and used. In such embodiments, the processor is arranged to determine timestamp pairs and generate composite timing messages by: determining, from those timestamps, a first plurality of timestamp pairs, each of which are the times of sending and receipt associated with the least delayed timing messages sent from the server to the client in the window; determining, from those timestamps, a second plurality of timestamp pairs, each of which are the times of sending and receipt associated with the least delayed timing messages sent from the client to the server in the window; generating, from the first and second plurality of timestamps a plurality of composite timing messages, each of which includes one of said first plurality of timestamp pairs and one of said second plurality of timestamp pairs.

Preferably the composite timing messages are also used to estimate the skew between the master clock and the salve clock.

The network may be a packet network (using technologies such Ethernet, IP, MPLS, etc.).

The timing messages are preferably timing messages under the IEEE 1588 Precision Time Protocol (PTP).

The system of this aspect can identify a set of minimally delayed packets (MDPs) or timing messages in the forward and reverse directions within a window of samples. Composites of these MDPs can be created and these composites represent packets or timing messages which would be minimally delayed in both the forward and reverse directions. As these composites are minimally delayed in both directions, their variability, magnitude and the degree of asymmetry are all minimised. These composites are therefore very valuable timing messages to use to update a Kalman filter (or any other) estimation algorithm.

The composite timing messages generated in the system of this aspect are ideal for updating the estimation algorithm for phase synchronisation as they are minimally delayed, have lower variance and suffer less asymmetry than any other timing messages in the window of samples from which they were created. Updating the estimation algorithm with better data can improve the accuracy of the estimation process.

The composite timing messages may also include further time information, either derived directly from the timestamps or calculated from the least delayed timing messages from which the composite timing message is generated.

In certain embodiments, when performing said estimation of the phase offset, the processor is further arranged to: operate a Kalman filter using the timestamps of said timing messages, including the steps of: initialising the Kalman filter by operating it using the measured timestamps of said timing messages until the estimates of the phase offset and skew are estimated to within a predetermined accuracy; and then repeatedly for each time window: operating the Kalman filter in prediction only mode to estimate the instantaneous phase offset based on the state vector derived from the composite timing message or messages from the previous time window; generating the composite timing message or messages for the current time window; and at the end of each time window, updating the Kalman filter with the values from the composite timing message or messages from the time window just ended.

In this manner, the Kalman filter can operate only on timing messages which have been identified as being minimally delayed and optimal. As there are a reduced number of these (compared, for example, to operating the estimation on timestamps from every exchange of timing messages), the update can be performed quickly at the end of each window, preferably between the last timing message of the preceding window and the first timing message of the next window.

The initialising step can be accomplished by a number of means, such as, for example, identifying lightly loaded conditions and operating the Kalman filter on each timestamp under such conditions.

Whilst the above embodiments use a Kalman filter, it will be appreciated that similar principles can be applied to other estimation/prediction models such as those described in Bletsas et al. [3].

Preferably the processor is further arranged to: calculate, for each of said least delayed timing messages, an estimate of the phase offset; and calculate, for each of said composite timing messages, an estimated mean phase offset which is the geometric mean of: the phase offset calculated for the timing message associated with said one of said first plurality of timestamps and the phase offset calculated for the timing message associated with said one of said second plurality of timestamps.

The estimated mean phase offset can then be used as the input to an estimation algorithm, such as a Kalman filter.

Preferably the processor is further arranged to calculate, as the time associated with each estimated mean phase offset, the geometric mean of the times of sending or receipt of the timing messages from which the estimated mean phase offset is derived.

Thus a plurality of composite timing messages can be created which have a phase offset and a time which represents the average of those values as calculated for the two least delayed timing messages which have been used to create the composite timing message.

In certain embodiments, when performing said estimation of the phase offset, the processor is further arranged to: operate a Kalman filter using the timestamps of said timing messages, including the steps of: initialising the Kalman filter by operating it using the measured timestamps of said timing messages until the estimates of the phase offset and skew are estimated to within a predetermined accuracy; and then repeatedly for each time window: operating the Kalman filter in prediction only mode to estimate the instantaneous phase offset based on the state vector derived from the composite timing messages from the previous time window; generating the composite timing messages for the current time window; and at the end of each time window, updating the Kalman filter with the values from the composite timing messages from the time window just ended, wherein the Kalman filter operates with a measurement equation:

$$\frac{( {T}_{1} [ {n}_{0} ] - {T}_{2} [ {n}_{0} ] ) + ( {T}_{4} [ {n}_{1} ] - {T}_{3} [ {n}_{1} ] )}{2} = {θ}_{E}$$

and a state equation:

$${X}_{n} = [ \begin{matrix}{θ}_{n} \\ {α}_{n}\end{matrix} ] = [ \begin{matrix}1 & Δ T \\ 0 & 1\end{matrix} ] [ \begin{matrix}{θ}_{n - 1} \\ {α}_{n - 1}\end{matrix} ] + [ \begin{matrix}{w}_{θ , n} \\ {w}_{α , n}\end{matrix} ] = {AX}_{n - 1} + {w}_{n} ,$$

and further wherein, after the step of initialising the Kalman filter:
   T₁[n₀], T₂[n₀], T₃[n₁] and T₄[n₁] are, respectively, the time of sending of the least delayed timing message, from which the composite timing message is generated, sent from the server to the client; the time of receipt of said least delayed timing message sent from the server to the client; the time of sending of the least delayed timing message, from which the composite timing message is generated, sent from the client to the server; and the time of receipt of said least delayed timing message sent from the client to the server; θ_{E} is the estimated mean phase offset value used by the estimation algorithm; θₙ and αₙ are the offset and skew estimates of the slave clock compared to the master at time n at the output of the estimation algorithm; ΔT is the time period between the time associated with consecutive estimated mean phase offsets.

In certain embodiments, when detecting the least delayed timing messages in each direction, the processor is arranged to: determine, from said timestamps, a forward displacement factor which is the difference between the interval between the times of receipt of successive first timing messages by the client and the interval between the times of sending of said successive first messages by the server; determine, from said timestamps, a reverse displacement factor which is the difference between the interval between the times of receipt of successive second timing messages by the server and the interval between the times of sending of said successive second timing messages by the client; maintain a running sum of said forward displacement factors over a predetermined time period; maintain a running sum of reverse displacement factors over a predetermined time period; and determine the least delayed timing messages from said running sums.

In certain embodiments, the processor is further arranged to estimate the variance of the measurement noise for the phase offset estimated for each of the least delayed timing messages. For example, this may be done by comparing the distance between the running sums of displacement factors at the times of the least delayed timing messages.

In certain embodiments the processor may be further arranged to determine or estimate the bias or offset between the instantaneous phase offset predicted by the estimation algorithm and the phase offset estimated directly from the least delayed timing messages. A stable estimate of this bias can be obtained by determining the bias from a plurality of least delayed timing messages and averaging them, for example using an exponentially weighted moving average filter.

The processor may use this estimated bias in the event that it becomes impossible to obtain timing messages or timestamps in one of the directions, or in the event that timing messages in one direction are subject to significant disruption or delay.

In such situations, the bias may be used to estimate the instantaneous phase offset from the timing messages which are received or which are not subject to disruption or delay.

The calculation of such a bias can also be used as a check on new candidates for least delayed timing messages. For example, if the absolute distance of the phase offset estimated from a candidate least delayed timing message from the predicted phase offset using the bias is above a predetermined threshold then the candidate least delayed timing message can be ignored and not used in future updates.

In certain embodiments, the processor is further arranged to determine the load conditions on the network between the server and the client and, if the load conditions are determined to be low in a window, store the composite timing messages determined in said window in a memory, whilst, if the load conditions are determined to be high in a window, use composite timing messages from an earlier window stored in said memory in the estimation of the phase offset.

In high network load conditions or when there is a change to the routing of traffic, the absolute delay of the least delayed timing messages can increase significantly. This shift in the values of the least delayed timing messages can result in the method of this aspect having difficulty or even being unable to detect/verify the true least delayed timing messages and may therefore result in no composite timing messages being created for use in the estimation process for the phase offset. This can impair the timing synchronisation and cause decline in the accuracy of the synchronization approach.

Preferably these embodiments operate by detecting changes in network load conditions (both increases and decreases in network load) and determining any significant changes. When a significant change in load condition is determined the shift in phase is considered and can be used to modify the attributes associated with the least delayed timing messages.

Preferably, when determining the load conditions, the processor is arranged to: calculate an estimate of a statistical characteristic of the queuing delay in each of said windows; and compare the estimate from the window in which the load conditions are being determined with the estimate from one or more previous windows and comparing the differences to a predetermined threshold.

Preferably, if the load conditions are determined to be high in a window, the processor is arranged to use composite timing messages stored in said memory to adjust composite timing messages determined in that window.

Thus the effects of high load conditions on the determination of the least delayed timing messages and their use can be reduced or minimized.

The system of the present aspect may include any combination of some, all or none of the above described preferred and optional features.

The processor of the slave device of the above aspect preferably operates by performing a method according to the first aspect of this invention, as described above, but need not do so.

Embodiments of the present invention are developed from an understanding of the critical importance of being able to identify and effectively use MDPs for time and frequency synchronization. The importance of MDP is discussed further in U.S. application Ser. No. 15/358,229 from the present inventors, which was filed on the same day as the present application and the contents of which are hereby incorporated by reference.

From the discussion in the above application, it can be seen that a Kalman filter implementation uses θ_{E} to represent the practical phase offset which can be estimated, and θ_{T} to represent the true phase offset. The difference between the estimated phase offset, θ_{E}, and the true offset, θ_{T}, is dominated by the difference between the estimated minimum forward queuing delay and the estimated minimum reverse queuing delay (see equations 8, 9, 10 in the above co-pending application for further explanation). Thus if it is possible to find a way to reliably identify the minimum forward delayed timing messages and the minimum reverse delayed timing messages, a very accurate estimate of the true phase offset could be obtained.

However, since the minimum delayed timing messages occur at random times on the forward and reverse paths and because the timestamps T₁, T₂, T₃, T₄ (being respectively, the time of sending of a first message from the master to the slave, according to the master clock; the time of receipt of said first message by the slave, according to the slave clock; the time of sending of a second message from the slave to the master, according to the slave clock; and the time of receipt of said second message by the master, according to the master clock) are monotonically increasing, it is difficult to directly identify the timestamps which experience minimum delay.

The phase offset of the slave clock with respect to master clock can be defined as follows:

T₁[n]+q_{f}[n]+d_{f}=T₂[n]+θ_{T}[n] 1a

T₄[n]−qᵣ[n]−dᵣ=T₃[n]+θ_{T}[n] 1b

Where d_{f} and dᵣ are the fixed delays on the forward and reverse paths respectively.

Manipulating 1a and 1b together it can be seen that:

2θ_{T}(n)=(T₁(n)+T₄(n))−[(T₂(n)+T₃(n))+(q_{f}(n)−qᵣ(n))+(d_{f}−dᵣ)]

However, as discussed in [1] as q_{f}(n), qᵣ(n), d_{f} and dᵣ are unknown, only the phase, θ_{E}(n), can be estimated:

2θ_{E}(n)=(T₁(n)+T₄(n))−(T₂(n)+T₃(n)) 2

By inspection it is clear that the values of (q_{f}[n]+d_{f}) and −(qᵣ[n]+dᵣ) both contribute directly to the difference in phase estimate between 2θ_{E}(n) and 2θ_{T}(n).

θ_{Ef}[n] can be defined as the forward instantaneous phase offset contribution due to the forward path delay only. Similarly, θ_{Er}[n], can be defined as the reverse instantaneous phase offset contribution due to the reverse path delay only. Thus, from 2, and the definitions above:

θ_{Ef}[n]=T₁[n]−T₂[n] 3a

θ_{Er}[n]=T₄[n]−T₃[n] 3b

These 2 phase offset contributions can be combined to find the overall phase offset estimate, θ_{E}[n]. Thus θ_{E}[n] is:

θ_{E}[n]=(θ_{Ef}[n]+θ_{Er}[n]) 4

as derived from equations 2, 3a and 3b.

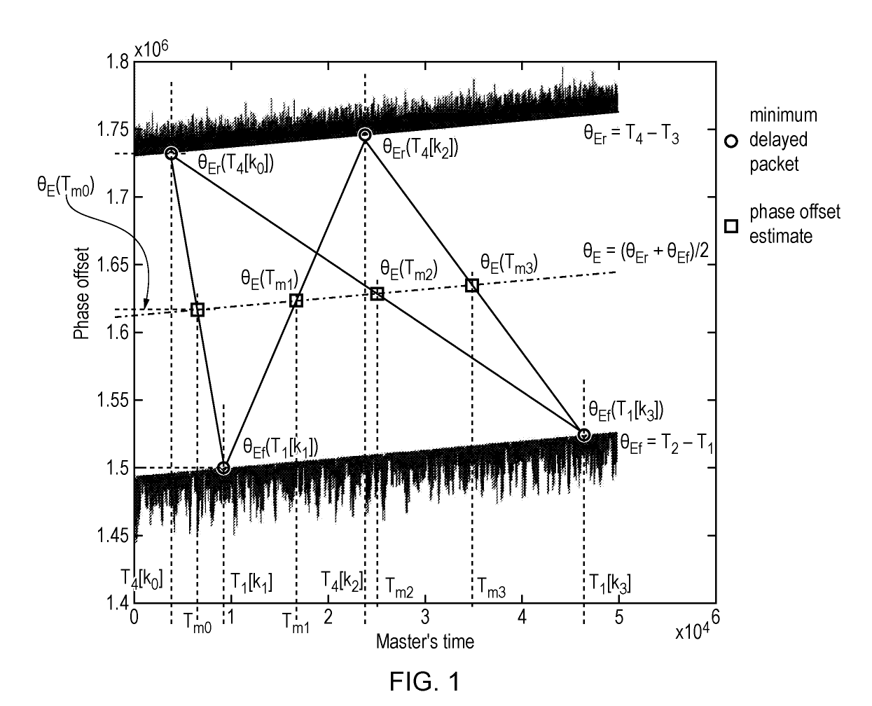

A graphical representation of θ_{Ef}, θ_{Er} and their relation with θ_{E}[n] is illustrated in FIG. 1.

In FIG. 1, θ_{Er} and θ_{Ef} are shown as continuously growing. This growth is caused by the skew (fractional frequency offset) between the master and the slave clocks. Also, it will be noticed that minimally delayed timing messages (for the forward and reverse paths) are distributed randomly along the time axis. These two effects make it impossible to directly use the MDPs from different time instants to compute the instantaneous phase offset, θ_{E}[n]. This is because equation 2 (and 3a, 3b) assume the timestamps T₁, T₂, T₃, T₄ are from the same set of two way message exchanges (and which are assumed to occur within a short time period).

In order to resolve the above problem, an assumption is applied. As the underlying hardware clock is controlled by an OCXO oscillator (or some other oscillator with similar stability), it can be assumed that θ_{E} increases linearly over a typical window length of 60 seconds (in direct proportion to the value of the oscillator's skew). The value of the skew, α[n], for each time step within the window can be assumed to be fixed over the 60 second period).

Using the assumption of linearity of the instantaneous phase offset over a short period window, linear combinations of the plurality of estimates of the θ_{Ef} and θ_{Er} can be used to create several θ_{E} estimations. These generated θ_{E} values (FIG. 1) are the ones least impacted by queuing delay on both the forward and reverse paths within the window. For clarity note that each θ_{E} value is not based on real timestamps but instead it, and its associated time sample, are both derived from one real forward and reverse MDP message exchanges separated in time. This combination of forward and reverse message data from different message exchanges is only valid because of the assumed linearity of the phase offset. These composite θ_{E} values are the most minimally impacted by queuing delays and are thus highly valuable drivers of the updates of the Kalman filter phase and skew estimates.

The phase offset estimation process operates as follows:
1. The incoming timestamps T₁(n), T₂(n), T₃(n) and T₄(n) are processed in non-overlapping windows, where the typical window size is 60 seconds.
2. During the initialization phase, the Kalman filter (“KF”) is operated to ensure it has converged and has accurate estimates of the phase offset and skew. This can be achieved using any known approach. A further approach is described in the co-pending application identified above which involves identifying lightly loaded conditions and operating the Kalman filter on each timestamp to yield stable and accurate estimates of skew and phase offset. Following the initialization phase the Kalman filter then operates as described in the following steps.
3. The Kalman filter is operated in prediction only mode based on the latest parameters derived from the measurement data from the previous window (see step 9). (In prediction only mode no measurement driven updates occur and the state estimates from the previous time step create an estimate of the state at the current time step.)
4. In the current window, calculate the values of (T₁(n)−T₂(n)), and (T₄(n)−T₃(n)) for each value of n in the window.
5. Identify one (or more) largest value of T₁(n)−T₂(n) (see FIG. 1 from which it can be seen that the maximum value of θ_{Ef} corresponds to the minimum delayed forward timing messages. Note: that the (T₁(n)−T₂(n)) values are negative and hence the highest absolute values corresponds to the minimally delayed timing messages). In the subsequent description of this step and the following steps it is assumed that more than one largest value is processed. Store the values and the time samples where they occur. As per FIG. 1, the values are designated θ_{Ef}(T₁[k₁]) and θ_{Ef}(T₁[k₃]) which occur at time samples T₁[k₁] and T₁[k₃] respectively. Note that the T₁ timestamps from the Master clock are used to identify the time samples at which the two largest values occur.
6. Identify one (or more) smallest value of T₄(n)−T₃(n). Store the values and the time samples where they occur. As per FIG. 1, the values are designated θ_{ET}(T₄[k₀]) and θ_{Er}(T₄[k₂]) which occur at time samples, T₄[k₀] and T₄[k₂] respectively. Note again that the timestamps from the Master clock are used to identify the samples at which the two smallest values occur but in this case T₄ timestamps are used.
7. As FIG. 1 illustrates, all possible phase estimates are calculated as the geometrical mean of the values θ_{Er} and θ_{Ef}, that is for θ_{Er}(T₄[k₀]) and θ_{Ef}(T₁[k₁]) the geometrical mean θ_{E} is θ_{E}(Tₘ₀)=(θ_{Ef}(T₁[k₁])+θ_{Er}(T₄[k₀]))/2.
   The other geometrical mean values in the window are calculated as:

θ_{E}(Tₘ₁)=(θ_{Ef}(T₁[k₁])+θ_{Er}(T₄[k₂]))/2

θ_{E}(Tₘ₂)=(θ_{Ef}(T₁[k₃])+θ_{Er}(T₄[k₀]))/2

θ_{E}(Tₘ₃)=(θ_{Ef}(T₁[k₃])+θ_{Er}(T₄[k₂]))/2
As there are 4 minimally delayed timing messages identified in the window illustrated in FIG. 1, 4 geometrical mean values are calculated. If there were more minimally delayed timing messages identified, more geometrical means would be calculated. Note that the above θ_{E}(Tₘ₀), . . . , θ_{E}(Tₘ₃) are basically the instantaneous phase offset measurements required for the update of the KF as further described in step 9.
8. The time samples at which these geometrical mean values occur are identified as the mid-point between the time samples at which the minimum values occur. Thus for the geometrical mean of θ_{Er}(T₄[k₀]) and θ_{Ef}(T₁[k₁]), the time mid-point is calculated as:

Tₘ₀=(T₁[k₁]+T₄[k₀])/2.
Similarly, for other mid-points:

Tₘ₁=(T₁[k₁]+T₄[k₂])/2.

Tₘ₂=(T₁[k₃]+T₄[k₀])/2.

Tₘ₃=(T₁[k₃]+T₄[k₂])/2.
9. The general form of the Kalman filter measurement equation is given by:

(T₁[n]−T₂[n]+T₄[n]−T₃[n])/2=8[n]+v[n]
and the Kalman filter state equation is:

$${X}_{n} = [ \begin{matrix}{θ}_{n} \\ {α}_{n}\end{matrix} ] = [ \begin{matrix}1 & Δ T \\ 0 & 1\end{matrix} ] [ \begin{matrix}{θ}_{n - 1} \\ {α}_{n - 1}\end{matrix} ] + [ \begin{matrix}{w}_{θ , n} \\ {w}_{α , n}\end{matrix} ] = {AX}_{n - 1} + {w}_{n} ,$$

The estimated phase values, θ_{E}(Tₘ₀), θ_{E}(Tₘ₁), θ_{E}(Tₘ₂) and θ_{E}(Tₘ₃) are considered to be the optimal estimates of instantaneous phase offset at these time instances (because they are derived from the MDPs). Now the Kalman filter is updated as follows:
   a. Compute ΔT for the current measurement.
      The appropriate value of ΔT to use for the calculated geometrical means depends on which time sample the update phase is occurring at. That is ΔTₘ₁=Tₘ₁−Tₘ₀ (ΔTₘ₂=Tₘ₂−Tₘ₁, etc.) and for ΔTₘ₀ it is the time period between Tₘ₀ and the T_{mN} from the previous window, where T_{mN} was the last time sample at which the geometrical mean was identified. If there were 4 minimally delayed timing messages identified in the previous window, then T_{mN} would be Tₘ₃ from the previous window.
   b. Predict KF states using previously computed ΔTₘₓ and update these predictions with the corresponding measurement θ_{E}(Tₘₓ), where the y[n] for the measurement is (with respect to step 9 and equations 3a, 3b) as follows:

y[n]=_{E}(Tₘₓ)=[n]+v[n]
Thus we observe that the usual timestamp based measurement value for the Kalman filter update phase is replaced with the calculated value, θ_{E}(Tₘₓ). The exact measurement noise, v[n], is replaced with the estimated noise, R[n]. R[n] is defined in the section below. The steps 9a. and 9b. are repeated for all mid-points Tₘₓ and related θ_{E} values.

### Detection of the MDPs.

The single most important thing in the process of selection of the optimal packets or timing messages for instantaneous phase offset estimation is to be able to identify MDPs. It is clear that it is difficult to identify MDPs using θ_{Ef}, θ_{Er}, when the oscillator's skew is present. As shown in FIG. 1, both quantities (θ_{Ef}, θ_{Er}) are monotonically increasing due to skew. However, it is possible to use the output of the cumulative sums (for example as discussed in the co-pending application referred to above) to easily identify the first three MDPs (or any other arbitrary number) for both forward and backward paths.

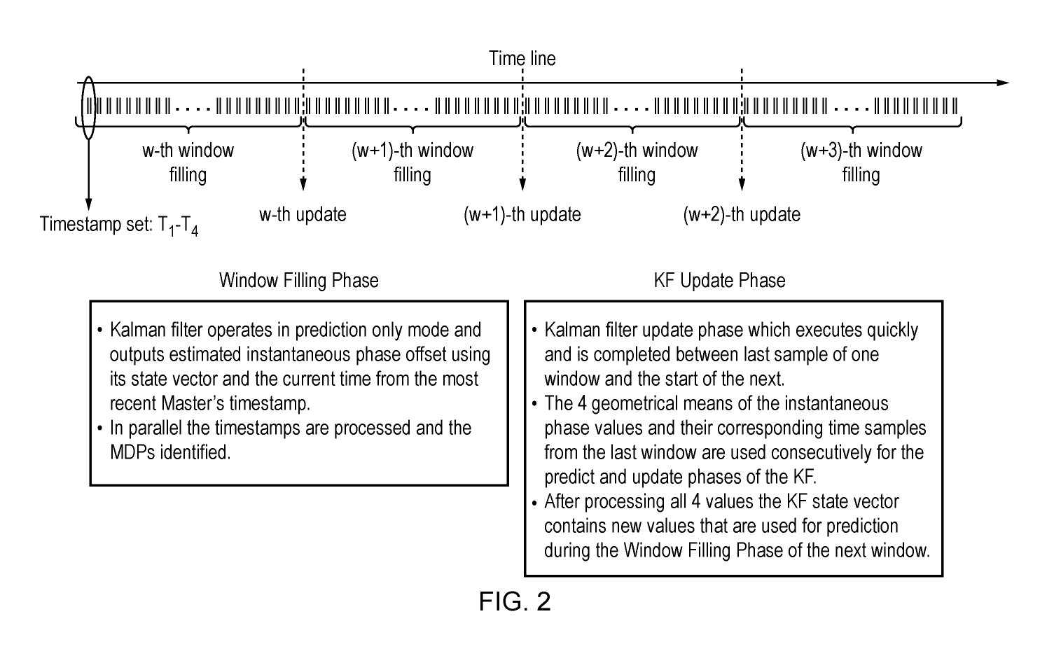

As the output of the cumulative sum is no longer monotonically increasing, but rather a very slowly drifting quantity (this drift is much slower than the aforementioned length of the window in which we are tracking MDPs), the delays of the timing messages can be easily directly tracked and compared and hence sorted quite effectively. The output of this sorting process after the Window Filling Phase has finished (see FIG. 2) would yield the following values: D_{fsumsort}[0], D_{fsumsort}[1]; Dᵣₛᵤₘₛₒᵣₜ[0], Dᵣₛᵤₘₛₒᵣₜ[1] and their corresponding θ_{Ef}, θ_{Er} and Tₘ₀ to Tₘ₃ values as depicted in FIG. 1. Two further minimal values are also identified, i.e., D_{fsumsort}[2] and Dᵣₛᵤₘₛₒᵣₜ[2]. Note that the value indexed as zero is the minimum, and the values are sorted in the ascending magnitude order.

The sorted D_{fsumsort} and Dᵣₛᵤₘₛₒᵣₜ values can be further used for noise variance estimation as described below. The D_{fsumsort}[2] and Dᵣₛᵤₘₛₒᵣₜ[2] values are identified exclusively for the noise variance estimation discussed further below.

### Measurement Noise Variance Estimation for MDP Derived Instantaneous Phase Offset Measurements.

The measurement noise variance helps the KF to converge properly to a stable estimate of the state values. Therefore, it is important to provide the KF with the estimate of the measurement noise of the instantaneous phase offset derived from MDPs as described above. Clearly, the higher the background traffic, the lower the probability of a “true” MDP being found, and the more variability in its absolute value. This fact has to be observable from the sorted cumulative sum values, as they reflect the packet delays directly. To estimate the variance of the discovered MDPs, we can simply use the distance between the first and the third sample from the sorted cumulative sum as follows:

R_{fmin}[w]=EWMA{(D_{fsumsort}[2]−D_{fsumsort}[0])²} 5a

Rᵣₘᵢₙ[w]=EWMA{(Dᵣₛᵤₘₛₒᵣₜ[2]−Dᵣₛᵤₘₛₒᵣₜ[0])²} 5b

where w is the window's index, and EWMA is the filtering factor with time constant τ which can typically be set to 60. The logic behind equations 5a and 5b above is simple. With increasing background traffic load, there is more variation in between the observed minimum packet delays, i.e., the distance between the first and third found MDP is bigger, which in turn, increases the estimate of the measurement noise variance from 5a, 5b as required.

### One Way Estimation of the Instantaneous Phase Offset

There may be situations in reality during which one-way mode operation may be required. For example, it may happen that only either Sync or DelayReq messages are received (forward direction or reverse direction timing messages), or that identified MDPs are too distant from the “true” minimally delayed timing message (see discussion regarding the validity of the MDPs below). In such conditions the following approach may be used. This algorithm is divided to two phases: training and prediction phase.

### a) Training Phase

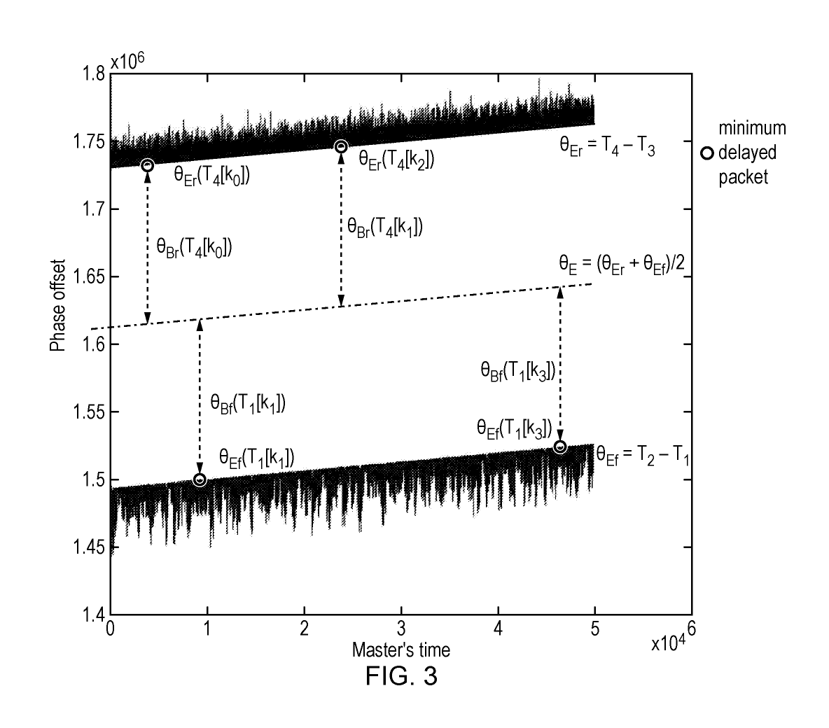

During normal two way mode operation, the following technique can be used to find a bias (or offset) θ_{Bf}, θ_{Br} between the instantaneous phase offset θ predicted by the KF and θ_{Ef}, θ_{Er} derived from MDPs as depicted in FIG. 3.

This bias can be found using the following equations:

θ_{Bf}(T_{M})={θ_{Ef}(T_{M})−(θ_{Mlast}+α_{Mlast}·(T_{M}−T_{Mlast}))} 6a

θ_{Br}(T_{M})={θ_{Er}(T_{M})−(θ_{Mlast}+α_{Mlast}·(T_{M}−T_{Mlast}))} 6b

where T_{M} is the time instant of the MDPs measured on the master time scale (i.e. T₁ or T₄ time stamp as per FIG. 3), θ_{Mlast} and α_{Mlast} are the states of the KF after the last update, and T_{Mlast} is the time at which the last KF's update happened (see 1.a in the above text).

In order to get more stable bias estimates, the values of the bias derived using 6a, 6b can be smoothed by an EWMA filter as illustrated below:

θ_{Bfs}=EWMA{θ_{Bf}(T_{M})}=EWMA{θ_{Ef}(T_{M})−(θ_{Mlast}+α_{Mlast}·(T_{M}−T_{Mlast}))} 7a

θ_{Brs}=EWMA{θ_{Br}(T_{M})}=EWMA{θ_{Er}(T_{M})−(θ_{Mlast}+α_{Mlast}·(T_{M}−T_{Mlast}))} 7b

### b) Prediction Phase

In case only one-way messages are obtained (i.e. T₁, T₂ or T₃, T₄), the algorithm enters a prediction phase. In the prediction phase, the trained biases θ_{Bfs}, θ_{Brs} are used to find the instantaneous phase offset as follows:

θ_{E}(T_{M})=θ_{Ef}(T_{M})−θ_{Bfs} 8a

θ_{E}(T_{M})=θ_{Er}(T_{M})−θ_{Brs} 8b

The output of 8a is used to update the KF as in the above algorithm flow (see, Steps 9a and 9b) when there is no valid reverse MDPs available in the window. Similarly 8b is used when there is no valid forward MDPs available in the window.

### MDPs Validity Verification

After convergence of the KF and during the normal two-way mode operation when θ_{Bfs}, θ_{Brs} are already trained (as explained above), the measured bias can be used to invalidate MDPs that are not the “true” MDPs. Due to the stability of the KF estimates, and given the assumption that true MDPs do not vary too much in time, if the absolute distance of the current MDP from the KF predicted θ_{E} (using equations 6a, 6b) is above a threshold (typical values for this threshold can be between 500 ns and 1 μs), it can be safely assumed that the “true” MDP was not obtained in that window and thus these MDP samples can be ignored, i.e., the Kalman filter is not updated using these samples.

### Operation in Extreme Conditions

One possible limitation of the phase offset estimation based on optimal timing messages method of the above embodiments is a noticeable increase in the delay of the Minimally Delayed Packets (MDPs) or timing messages during extreme conditions (e.g. 50% load over more than 10 enterprise switches). This increase in the absolute delays of the MDPs can lead to a failure in the system to identify the MDPs because the MDP detection algorithm does not consider timing messages as candidate MDPs if their absolute delay is greater than a threshold. Thus when no MDPs are identified, the system may enter a holdover mode, however, this change of state to the holdover mode is premature.

A further embodiment of the present invention provides an algorithm that compensates for the shift of the absolute delay that enables MDPs to be identified even in high network load conditions. This algorithm improves the robustness of the overall system by avoiding premature changes to the holdover state.

There are two challenges to be overcome:
1. Reliable detection of a dynamic change in the load conditions.
2. Estimation of the phase shift due to the increase in the absolute delay of the MDPs.

### Dynamic Load Change Detection

In order to detect changes in the traffic load reliably a variable which exhibits very distinct values for different traffic load conditions and has low variance during stable conditions is required.

The previous embodiments of this invention showed that MDPs could be identified using estimates of the queuing delays (D_{fsum}, Dᵣₛᵤₘ) in a long window of samples (over a minute). For the present embodiment, it is assumed that traffic conditions do not change significantly over a short period of time, that is, not faster than approximately every five minutes. This allows the detection algorithm to identify the change and settle to a new steady state level.

Building on the above embodiments, advantage can be taken of the long window (about 60 seconds of data) to compute a very stable estimate of the statistical characteristic (mean/median/mode) of the queuing delay. Preference is given to the sample mean (average), as it can be computed iteratively as follows:

$$\overline{X} = \frac{1}{N} {\sum }_{i = 0}^{N - 1} x [ i ] \qquad 9$$

where x is either D_{fsum} or Dᵣₛᵤₘ. Since we are computing the characteristics over many samples, the resulting stability of the statistical parameter is greatly improved. For a simple sample mean (noted X̅) its variance over N samples is:

$${σ}_{\overline{X}}^{2} = Var \{ \overline{X} \} = \frac{{σ}_{X}^{2}}{N} \qquad 10$$

where σ_{X} is the sample variance. For example, if the queuing delay has sample variance of 400 μs, the variance of the sample mean over a window of 60 seconds with sampling rate of 128 messages per second is

$${σ}_{\overline{X}}^{2} = \frac{400 µs}{128 \cdot 60} = 52 ns$$

Regardless of the sample variance, the reduction factor is higher for longer windows and higher sampling rates. In the above example the reduction factor is more than 7600 (128*60). Given that the extreme changes in the traffic load would result in the average queuing delays shifting by more than tens of microseconds, a simple average over a window as described above gives an excellent indication of condition changes.

To flag changes of note in a variable over time a threshold is required to indicate that a significant change has occurred, i.e., the difference between the old value and the new value of the average queuing delay is compared to a threshold; if the threshold is exceeded a change in load condition is flagged. A suitable value for the threshold in the present embodiment is approximately 4 μs. The threshold selection will depend on a number of factors, such as network setup (number of switches), device switching speed and network transmission speed (0.1/1/10 Gbits). The thresholding algorithm should ideally be trained during stable conditions. For example, this might cover 3 measurement windows (typically 3×60 seconds). From these measurement windows, the threshold could be computed as a simple mean of the averages discussed above for those windows plus an allowance for variance (e.g. 2 or 3 sigma=std. dev.) of those averages.

The comparison can be implemented using consecutive windows directly, or by filtering the average values from the previous windows using an EWMA filter. The filtered result is compared to the new average delay. The comparison also indicates, by the sign of the result, whether the change was to a less heavily loaded or more heavily loaded condition (which will be reflected in a decrease/increase in the average delay value respectively).

Since the D_{fsum} (Dᵣₛᵤₘ) computation is based on the sum of estimated values (resulting in Wiener drift), it is impossible to compare windows which are separated significantly in time, unless compensation for the Wiener drift is implemented. As an example of the Wiener drift, let us consider two windows of 60 seconds duration, one indexed L and the other indexed (L-60). The two windows would be separated by an hour time difference. Based on the precision of the skew used for computation of the D_{fsum} (Dᵣₛᵤₘ), this may yield a significant bias for sample average values in the L and (L-60) windows making a direct comparison impossible. One approach to compensation of the Wiener drift is to normalize the computed sample average delay by subtracting the minimum delay, because both the average delay and the minimum delay will experience the same impact from Wiener drift, thus:

$${\overline{X}}_{norm} = ( \frac{1}{N} {\sum }_{i = 0}^{N - 1} x [ i ] ) - {x}_{min} \qquad 11$$

where x is either D_{fsum} or Dᵣₛᵤₘ and xₘᵢₙ is the minimum x in the window (MDP). X̅ₙₒᵣₘ is the normalized sample mean delay and it can be used to compare and contrast even very distant windows for other purposes like network traffic monitoring etc.

### Phase Offset Shift Estimation

The minimum packet delay through a number of switches may change slightly when a higher traffic load is applied, or, it will change significantly when the number of switches changes (rerouting of the PTP traffic path). In such cases the change in the minimum delay will cause a shift in the phase offset estimation, which will, in turn, produce an increased timing error at the slave clock output.

Specifically in relation to the embodiments described above, a significant shift in the minimum delay might result in the algorithm being unable to detect/verify the MDPs and therefore no MDPs would be available to the estimation process. The algorithm described below compensates for the significant changes of the MDPs that are triggered by dynamic changes in the network (large traffic load change or a change to the number of switches).

First, it is assumed that the algorithm described in the previous section is used to detect the dynamic changes in the traffic load conditions. It is also assumed that during good conditions the instantaneous phase offsets in the forward direction plus the instantaneous phase offsets in the reverse direction are stored. Thus, during good conditions the MDPs and the associated instantaneous phase offsets are identified (for example using the above embodiments), and their values stored.

Below the algorithm is described in relation to reverse direction timing messages only, but it will be readily appreciated that the same principles can be applied to the forward direction timing messages.

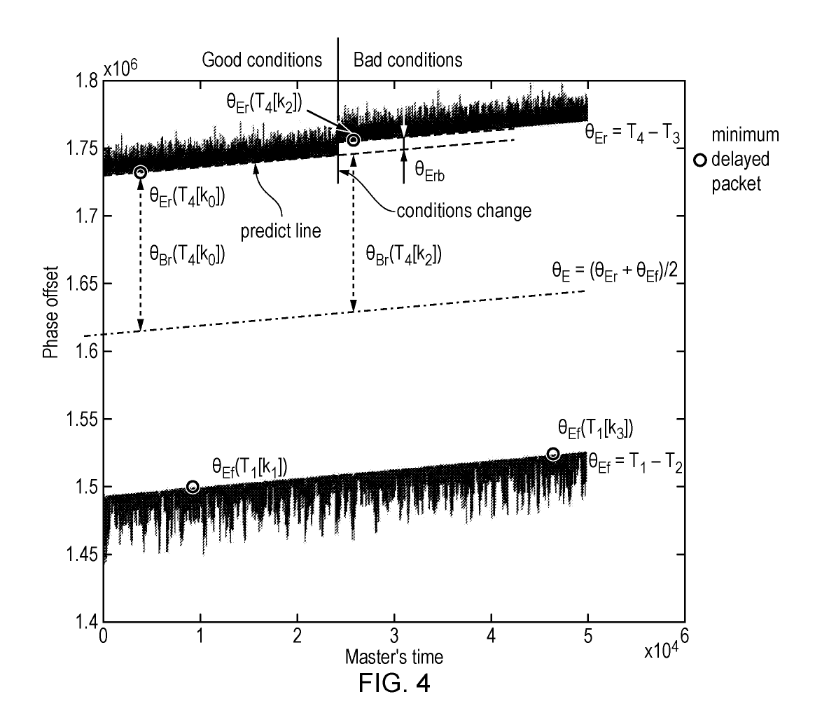

As illustrated in FIG. 4, during good conditions the instantaneous offset θ_{Er}(T₄[k₀]) corresponding to the identified MDP is stored. The value of the phase offset, θ_{Er}(T₄[k₂]), at time instant T₄[k₂], is driven by both the skew and the increase in the reverse packet delay over the time period T₄[k₀] to T₄[k₂].

The expected phase offset at T₄[k₂] due to the impact of skew alone can be derived from the following:

Δθ=α·ΔT

where Δθ is the phase change due to the skew, α over the time interval ΔT. Note that it is assumed that the skew is constant over this period. Using this formula, the expected value, θ_{Ers}(T₄[k₂]) of the phase offset at T₄[k₂] due to the impact of skew only can be calculated as follows:

θ_{Ers}(T₄[k₂])=θ_{Er}(T₄[k₀])+α·(T₄[k₂]−T₄[k₀]) 12

The skew value α is provided by the Kalman filter as described in the above embodiments and is assumed to be constant over the time period of interest due to the high stability of the system's oscillator and the efficacy of the Kalman filter.

Now it is possible to independently consider how the phase offset has been impacted by the change in network load from T₄[k₀] to T₄[k₂]. From FIG. 4 it can be seen that the MDP at T₄[k₂] is distinctly different from what its expected value would be due to skew alone. This shift in phase value θ_{Erb} (see FIG. 4) is caused by the increased reverse packet delay at T₄[k₂]. θ_{Erb} is calculated as:

θ_{Erb}=θ_{Ers}(T₄[k₂])−θ_{Er}(T₄[k₂]) 13

Substituting equation 12 into 13 gives:

θ_{Erb}=θ_{Er}(T₄[k₀])+α(T₄[k₂]−T₄[k₀])−θ_{Er}(T₄[k₂]) 14

When a change in load condition is flagged, the value of θ_{Erb} is calculated and compared to a threshold. If θ_{Erb} is greater than the threshold (typically set at 250 ns), a phase shift due a change in the variance of MDPs from one window to the next is considered to have occurred. If θ_{Erb} is less than the threshold, then no significant shift in phase offset, due to a change to the MDP variance, is indicated and the value of θ_{Erb} is set to zero.

To address the phase offset caused by the increase in the minimum packet delay, compensated phase offsets at the identified MDPs positions are computed as follows:

θ_{Erc}(T₄)=θ_{Er}(T₄)+θ_{Erb} 15

where θ_{Erc}(T₄) is the corrected phase offset estimate which will be used to update the Kalman filter as described in the above embodiments.

The compensation mechanism of equation 15 continues to operate whilst the network load condition remains in a steady state.

The compensation mechanism will not be invoked in a subsequent window if a change to a lightly loaded network condition is indicated. If a lightly loaded network condition is indicated, θ_{Erb} is set to zero.

### Compensation of the Residual Shift

It will be observed that even though the slight changes in the absolute delay of the MDPs can be compensated for by the above method, some residual shift is sometimes present. The following method helps to further diminish any outstanding error caused by the phase shifts.

The method described below assumes that the skew estimated by the KF is very accurate (based on observations, this can be, on average, better than 1 e⁻¹⁰ second per second) within the time period of at least 10 minutes. This is indeed true for high quality oscillators (OCXO) for the range of traffic load conditions laid out in the ITU-T G.8261 standard.

During good conditions (indicated by the algorithm described above) the last estimated instantaneous phase offset value along with its time index, i.e., θ_{E}(Tₘ) is stored. When bad conditions are detected and the phase shift has been estimated and compensated for, the system is allowed to continue to operate for approximately another 10 minutes using the estimated and corrected phase values (Equation 15) as inputs to the KF. After 10 minutes (time index Tₘ₊₁₀) the residual phase shift can be measured as follows:

θ_{Eres}=θ_{E}(Tₘ)+α(Tₘ₊₁₀−Tₘ)−θ_{E}(Tₘ₊₁₀) 16

where θ_{Eres} is the residual phase shift and θ_{E}(Tₘ₊₁₀) is the instantaneous phase offset estimated using KF at time instant Tₘ₊₁₀. This residual phase shift is then used as follows to give the final server's time estimate θ_{Efinal}:

θ_{Efinal}(T)=θ_{E}(T)+θ_{Eres} 17

where θ_{E}(T) is the KF's predicted value of the instantaneous phase offset at time instant T.

The systems and methods of the above embodiments may be implemented in a computer system (in particular in computer hardware or in computer software) in addition to the structural components and user interactions described.

The term “computer system” includes the hardware, software and data storage devices for embodying a system or carrying out a method according to the above described embodiments. For example, a computer system may comprise a central processing unit (CPU), input means, output means and data storage. Preferably the computer system has a monitor to provide a visual output display. The data storage may comprise RAM, disk drives or other computer readable media. The computer system may include a plurality of computing devices connected by a network and able to communicate with each other over that network.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

In particular, although the methods of the above embodiments have been described as being implemented on the systems of the embodiments described, the methods and systems of the present invention need not be implemented in conjunction with each other, but can be implemented on alternative systems or using alternative methods respectively.

### REFERENCES

1. U.S. Pat. No. 9,184,861 Aweya et al.−Method and devices for compensating for path asymmetry.
2. U.S. Pat. No. 9,112,628 Aweya et al.−Method and devices for synchronization.
3. A. Bletsas: “Evaluation of Kalman filtering for network time keeping,” IEEE Trans. on Ultrason., Ferroel., and Freq. Control, 09/2005.
4. Co-pending U.S. application Ser. No. 15/358,229

All references referred to above are hereby incorporated by reference.

1. A method of estimating the phase offset between a master clock in a server and a slave clock in a client, the server and the client being in communication over a network, the method including the steps of:
within a time window of predetermined duration, exchanging timing messages between the server and the client and recording timestamps which are the times of sending and of receipt of those messages according to the master and slave clocks;
determining, from those timestamps, at least one first timestamp pair, which is the times of sending and receipt associated with the least delayed timing message sent from the server to the client in the window;
determining, from those timestamps, at least one second timestamp pair, which is the times of sending and receipt associated with the least delayed timing messages sent from the client to the server in the window;
generating, from the first and second timestamp pairs at least one composite timing message, which includes said first timestamp pair and said second timestamp pair;
using said composite timing messages to estimate the phase offset between the master clock and the slave clock.

2. A method according to claim 1 wherein said estimation of the phase offset includes operating a Kalman filter using the timestamps of said timing messages, and includes the steps of:
initialising the Kalman filter by operating it using the measured timestamps of said timing messages until the estimates of the phase offset and skew are estimated to within a predetermined accuracy; and then
repeatedly for each time window:
operating the Kalman filter in prediction only mode to estimate the instantaneous phase offset based on the state vector derived from the composite timing message or messages from the previous time window;
generating the composite timing message or messages for the current time window; and
at the end of each time window, updating the Kalman filter with the values from the composite timing message or messages from the time window just ended.

3. A method according to claim 1 further including the steps of:
calculating, for each of said least delayed timing messages, an estimate of the phase offset; and
calculating, for each of said composite timing messages, an estimated mean phase offset which is the geometric mean of: the phase offset calculated for the timing message associated with said one of said first plurality of timestamps and the phase offset calculated for the timing message associated with said one of said second plurality of timestamps.

4. A method according to claim 3, further including the step of calculating, as the time associated with each estimated mean phase offset, the geometric mean of the times of sending or receipt of the timing messages from which the estimated mean phase offset is derived.

5. A method according to claim 4 wherein said estimation of the phase offset includes operating a Kalman filter using the timestamps of said timing messages, and includes the steps of:
initialising the Kalman filter by operating it using the measured timestamps of said timing messages until the estimates of the phase offset and skew are estimated to within a predetermined accuracy; and then
repeatedly for each time window:
operating the Kalman filter in prediction only mode to estimate the instantaneous phase offset based on the state vector derived from the composite timing messages from the previous time window;
generating the composite timing messages for the current time window; and
at the end of each time window, updating the Kalman filter with the values from the composite timing messages from the time window just ended,
wherein the Kalman filter operates with a measurement equation:
$$\frac{( {T}_{1} [ {n}_{0} ] - {T}_{2} [ {n}_{0} ] ) + ( {T}_{4} [ {n}_{1} ] - {T}_{3} [ {n}_{1} ] )}{2} = {θ}_{E}$$
and a state equation:
$${X}_{n} = [ \begin{matrix}{θ}_{n} \\ {α}_{n}\end{matrix} ] = [ \begin{matrix}1 & Δ T \\ 0 & 1\end{matrix} ] [ \begin{matrix}{θ}_{n - 1} \\ {α}_{n - 1}\end{matrix} ] + [ \begin{matrix}{w}_{θ , n} \\ {w}_{α , n}\end{matrix} ] = {AX}_{n - 1} + {w}_{n} ,$$
and further wherein, after the step of initialising the Kalman filter:
T₁[n₀], T₂[n₀], T₃[n₁] and T₄[n₁] are, respectively, the time of sending of the least delayed timing message, from which the composite timing message is generated, sent from the server to the client; the time of receipt of said least delayed timing message sent from the server to the client; the time of sending of the least delayed timing message, from which the composite timing message is generated, sent from the client to the server; and the time of receipt of said least delayed timing message sent from the client to the server;
θ_{E} is the estimated mean phase offset value used by the estimation algorithm;
θₙ and αₙ are the offset and skew estimates of the slave clock compared to the master at time n at the output of the estimation algorithm;
ΔT is the time period between the time associated with consecutive estimated mean phase offsets.

6. A method according to claim 1, further including the step of determining the load conditions on the network between the server and the client and, if the load conditions are determined to be low in a window, storing the composite timing messages determined in said window, whilst, if the load conditions are determined to be high in a window, using stored composite timing messages from an earlier window in the estimation of the phase offset.

7. A method according to claim 6, wherein the step of determining the load conditions includes the sub-steps of:
calculating an estimate of a statistical characteristic of the queuing delay in each of said windows; and
comparing the estimate from the window in which the load conditions are being determined with the estimate from one or more previous windows and comparing the differences to a predetermined threshold.

8. A method according to claim 6, wherein if the load conditions are determined to be high in a window, the stored composite timing messages are used to adjust composite timing messages determined in that window.

9. A time client having a slave clock and a processor, and connected to a master clock in a server over a network, wherein the time client is arranged to:
within a time window of predetermined duration, exchange timing messages with the server and record and receive timestamps which are the times of sending and of receipt of those messages according to the master and slave clocks,
and wherein the processor is arranged to:
determine, from those timestamps, at least one first timestamp pair, which is the times of sending and receipt associated with the least delayed timing message sent from the server to the client in the window;
determine, from those timestamps, at least one second timestamp pair, which is the times of sending and receipt associated with the least delayed timing message sent from the client to the server in the window;
generate, from the first and second plurality of timestamps, at least one composite timing message, which includes said first timestamp pair and said second timestamp pair; and
use said composite timing messages to estimate the phase offset between the master clock and the slave clock.

10. A time client according to claim 9 wherein, when performing said estimation of the phase offset, the processor is further arranged to:
operate a Kalman filter using the timestamps of said timing messages, including the steps of:
initialising the Kalman filter by operating it using the measured timestamps of said timing messages until the estimates of the phase offset and skew are estimated to within a predetermined accuracy; and then
repeatedly for each time window:
operating the Kalman filter in prediction only mode to estimate the instantaneous phase offset based on the state vector derived from the composite timing message or messages from the previous time window;
generating the composite timing message or messages for the current time window; and
at the end of each time window, updating the Kalman filter with the values from the composite timing message or messages from the time window just ended.

11. A time client according to claim 9 wherein the processor is further arranged to:
calculate, for each of said least delayed timing messages, an estimate of the phase offset; and
calculate, for each of said composite timing messages, an estimated mean phase offset which is the geometric mean of: the phase offset calculated for the timing message associated with said one of said first plurality of timestamps and the phase offset calculated for the timing message associated with said one of said second plurality of timestamps.

12. A time client according to claim 11, wherein the processor is further arranged to calculate, as the time associated with each estimated mean phase offset, the geometric mean of the times of sending or receipt of the timing messages from which the estimated mean phase offset is derived.

13. A time client according to claim 12 wherein, when performing said estimation of the phase offset, the processor is further arranged to:
operate a Kalman filter using the timestamps of said timing messages, including the steps of:
initialising the Kalman filter by operating it using the measured timestamps of said timing messages until the estimates of the phase offset and skew are estimated to within a predetermined accuracy; and then
repeatedly for each time window:
operating the Kalman filter in prediction only mode to estimate the instantaneous phase offset based on the state vector derived from the composite timing messages from the previous time window;
generating the composite timing messages for the current time window; and
at the end of each time window, updating the Kalman filter with the values from the composite timing messages from the time window just ended,
wherein the Kalman filter operates with a measurement equation:
$$\frac{( {T}_{1} [ {n}_{0} ] - {T}_{2} [ {n}_{0} ] ) + ( {T}_{4} [ {n}_{1} ] - {T}_{3} [ {n}_{1} ] )}{2} = {θ}_{E}$$
and a state equation:
$${X}_{n} = [ \begin{matrix}{θ}_{n} \\ {α}_{n}\end{matrix} ] = [ \begin{matrix}1 & Δ T \\ 0 & 1\end{matrix} ] [ \begin{matrix}{θ}_{n - 1} \\ {α}_{n - 1}\end{matrix} ] + [ \begin{matrix}{w}_{θ , n} \\ {w}_{α , n}\end{matrix} ] = {AX}_{n - 1} + {w}_{n} ,$$
and further wherein, after the step of initialising the Kalman filter:
T₁[n₀], T₂[n₀], T₃[n₁] and T₄[n₁] are, respectively, the time of sending of the least delayed timing message, from which the composite timing message is generated, sent from the server to the client; the time of receipt of said least delayed timing message sent from the server to the client; the time of sending of the least delayed timing message, from which the composite timing message is generated, sent from the client to the server; and the time of receipt of said least delayed timing message sent from the client to the server;
θ_{E} is the estimated mean phase offset value used by the estimation algorithm;
θₙ and αₙ are the offset and skew estimates of the slave clock compared to the master at time n at the output of the estimation algorithm;
ΔT is the time period between the time associated with consecutive estimated mean phase offsets.

14. A time client according to claim 9, wherein the processor is further arranged to determine the load conditions on the network between the server and the client and, if the load conditions are determined to be low in a window, store the composite timing messages determined in said window in a memory, whilst, if the load conditions are determined to be high in a window, use composite timing messages from an earlier window stored in said memory in the estimation of the phase offset.

15. A time client according to claim 14, wherein when determining the load conditions, the processor is arranged to:
calculate an estimate of a statistical characteristic of the queuing delay in each of said windows; and
compare the estimate from the window in which the load conditions are being determined with the estimate from one or more previous windows and comparing the differences to a predetermined threshold.

16. A time client according to claim 14, wherein if the load conditions are determined to be high in a window, the processor is arranged to use composite timing messages stored in said memory to adjust composite timing messages determined in that window.

17. A networked time system having:
a time server which has a master clock;
a time client having a slave clock and a processor; and
a network connecting said server and said client,
wherein the server and the client are arranged to, within a time window of predetermined duration, exchange timing messages with each other and record timestamps which are the times of sending and of receipt of those messages according to the master and slave clocks,
and wherein the processor in the client is arranged to:
determine, from those timestamps, at least one first timestamp pair, which is the times of sending and receipt associated with the least delayed timing message sent from the server to the client in the window;
determine, from those timestamps, at least one second timestamp pair, which is the times of sending and receipt associated with the least delayed timing message sent from the client to the server in the window;
generate, from the first and second timestamp pairs at least one composite timing message, which includes said first timestamp pair and said second timestamp pair; and
use said composite timing messages to estimate the phase offset between the master clock and the slave clock.

18. A networked time system according to claim 17 wherein, when performing said estimation of the phase offset, the processor is further arranged to:
operate a Kalman filter using the timestamps of said timing messages, including the steps of:
initialising the Kalman filter by operating it using the measured timestamps of said timing messages until the estimates of the phase offset and skew are estimated to within a predetermined accuracy; and then
repeatedly for each time window:
operating the Kalman filter in prediction only mode to estimate the instantaneous phase offset based on the state vector derived from the composite timing message or messages from the previous time window;
generating the composite timing message or messages for the current time window; and
at the end of each time window, updating the Kalman filter with the values from the composite timing message or messages from the time window just ended.

19. A networked time system according to claim 17 wherein the processor is further arranged to:
calculate, for each of said least delayed timing messages, an estimate of the phase offset; and
calculate, for each of said composite timing messages, an estimated mean phase offset which is the geometric mean of: the phase offset calculated for the timing message associated with said one of said first plurality of timestamps and the phase offset calculated for the timing message associated with said one of said second plurality of timestamps.

20. A networked time system according to claim 19, wherein the processor is further arranged to calculate, as the time associated with each estimated mean phase offset, the geometric mean of the times of sending or receipt of the timing messages from which the estimated mean phase offset is derived.

21. A networked time system according to claim 20 wherein, when performing said estimation of the phase offset, the processor is further arranged to:
operate a Kalman filter using the timestamps of said timing messages, including the steps of:
initialising the Kalman filter by operating it using the measured timestamps of said timing messages until the estimates of the phase offset and skew are estimated to within a predetermined accuracy; and then
repeatedly for each time window:
operating the Kalman filter in prediction only mode to estimate the instantaneous phase offset based on the state vector derived from the composite timing messages from the previous time window;
generating the composite timing messages for the current time window; and
at the end of each time window, updating the Kalman filter with the values from the composite timing messages from the time window just ended,
wherein the Kalman filter operates with a measurement equation:
$$\frac{( {T}_{1} [ {n}_{0} ] - {T}_{2} [ {n}_{0} ] ) + ( {T}_{4} [ {n}_{1} ] - {T}_{3} [ {n}_{1} ] )}{2} = {θ}_{E}$$
and a state equation:
$${X}_{n} = [ \begin{matrix}{θ}_{n} \\ {α}_{n}\end{matrix} ] = [ \begin{matrix}1 & Δ T \\ 0 & 1\end{matrix} ] [ \begin{matrix}{θ}_{n - 1} \\ {α}_{n - 1}\end{matrix} ] + [ \begin{matrix}{w}_{θ , n} \\ {w}_{α , n}\end{matrix} ] = {AX}_{n - 1} + {w}_{n} ,$$
and further wherein, after the step of initialising the Kalman filter:
T₁[n₀], T₂[n₀], T₃[n₁] and T₄[n₁] are, respectively, the time of sending of the least delayed timing message, from which the composite timing message is generated, sent from the server to the client; the time of receipt of said least delayed timing message sent from the server to the client; the time of sending of the least delayed timing message, from which the composite timing message is generated, sent from the client to the server; and the time of receipt of said least delayed timing message sent from the client to the server;
θ_{E} is the estimated mean phase offset value used by the estimation algorithm;
θₙ and αₙ are the offset and skew estimates of the slave clock compared to the master at time n at the output of the estimation algorithm;
ΔT is the time period between the time associated with consecutive estimated mean phase offsets.

22. A networked time system according to claim 17, wherein the processor is further arranged to determine the load conditions on the network between the server and the client and, if the load conditions are determined to be low in a window, store the composite timing messages determined in said window in a memory, whilst, if the load conditions are determined to be high in a window, use composite timing messages from an earlier window stored in said memory in the estimation of the phase offset.

23. A networked time system according to claim 22, wherein when determining the load conditions, the processor is arranged to:
calculate an estimate of a statistical characteristic of the queuing delay in each of said windows; and
compare the estimate from the window in which the load conditions are being determined with the estimate from one or more previous windows and comparing the differences to a predetermined threshold.

24. A networked time system according to claim 22, wherein if the load conditions are determined to be high in a window, the processor is arranged to use composite timing messages stored in said memory to adjust composite timing messages determined in that window.
